(19) United States
(12) Patent Application Publication
(10) Pub. No.: US 2007/0176729 A1
(43) Pub. Date: Aug. 2, 2007

(54) Remote controller for rotary potentiometer

(76) Inventor: Simon Roger Ebrey, Lawrenceville, GA (US)

Correspondence Address: SIMON ROGER EBREY, 1221 MYSTIC DRIVE, LOGANVILLE, GA, 30052, US

(21) Appl. No.: 11/656,831

(22) Filed: Jan. 23, 2007

Related U.S. Application Data
(60) Provisional application No. 60/762,757, filed on Jan. 27, 2006.

(51) Int. Cl. H01C 10/00

(52) U.S. Cl. 338/153

(57) ABSTRACT

Device for remote operation of rotary potentiometers consisting of a mounting bracket 10 supporting a flexible drive shaft 24 which has affixed to its supported end a control knob 2 and at its unsupported end a universal joint 26 which houses a thumb-screw 30 for capture of a rotary potentiometer shaft. Thus allowing the user to operate floor-mounted effects devices from a more natural standing position during a musical performances, rather than having to crouch down during said performance.

### CROSS REFERENCE TO RELATED APPLICATIONS

This application claims the benefit of provisional patent application Ser. No. 60/762,757, filed Jan. 27, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to rotary potentimeters, specifically those used in floor-mounted effects devices used for enhancing musical performances.

2. Prior Art

With the further development of electronic musical instruments in the mid-1960's, and the implementation of digital technology in the 80's and 90's, small, floor-mounted audio effect processors (FIG. 1) have become widely popular tools for enhancing and manipulating audio signals produced by electronic musical instruments, particulary the electric guitar.

These small, battery operated devices usually consist of a metal housing containing the various electronic components, a foot operated on-off switch, and a plurality of rotary potentiometers (FIG. 2) which provide independent adjustment of the various operating parameters and functions of the device.

It should be noted that, other than the differences in the type of effect available, the size/shape of the housing, and the number of rotary potentiometers, the basic configuration of these devices has remained virtually unchanged in the forty years since their introduction, and though a multitude of floor-mounted effects devices are now used world wide, several inadequacies are inherent in their operation:
1) Control over the devices is limited to the foot-operated on/off switch which only engages a pre-set effect to an audio signal. (Provides no actual manipulation or control over the effect.)
2) Being floor-mounted, access the manual controls (rotary potentiometers) is unavailable during normal use without the user stooping or crouching down. (This is often unpractical as the user is usually required to maintain a standing or sitting position in order to play his/her instrument, sing at a stand-mounted microphone, or more frequently, both.)
3) In order to make any adjustment to the manual controls, the user must either:
   a) Make any adjustments prior to each song/piece and hope the adjustment was accurate (This is inherently difficult due to the need of an audio signal as well as the exact tempo of the song/ performance in order to make adjustments that are often measured in milliseconds.)
   b) Wait until a pause in the song/performance provides time for the user to bend over and make a quick (and usually innaccurate) adjustment, all while his/her eyes constantly must adjust to an ever-changing or dimly-lit lighting situation.

Recently, one company has attempted to address this problem by marketing a floor-mounted apparatus that is designed to be positioned directly alongside the effects device it connected to.

A small metal housing with approximately the same dimensions as typical effect pedal has protruding from its top surface a short flexible metal shaft approx. 30 cm in length and a foot-operated see-saw lever. The shaft is rotated by a simple gear arrangement powered by the up and down movement of the foot lever.

Once the apparatus is in position next to an effect pedal, the flexible shaft is bent over 180° and attached to an effect pedals exposed potentiometer shaft with a hex wrench and set-screw.

A photographic representation of the currently marketed device is included in the Information Disclosure Document.

There are however, several inefficiencies in the currently marketed device:
1) Unnecessarily complicated/costly design.
2) Takes up extra floor space during performances/use.
3) Due to its shorter drive shaft, the currently marketed device can only function when placed directly next to an effects pedal:
If the user wishes to use the currently marketed device with an elongated effects processor (commonly known as a pedalboad) he/she is limited to those pedalboards having their control knobs located on either the extreme right or left hand side.
Note that many pedalboards are equipped with see-saw type foot levers on one or both sides and are thus restricted from use with the currently marketed device.
4) The currently marketed device is capable of controlling only one rotary potentiometer at a time.
Even a two-channel version of this device would be too bulky and cost prohibitive to be practical.
5) Guitar players are used to making adjustments to control knobs with their hands not their feet. When trying to make fast, precise adjustments in increments that are often measured in milliseconds, replacing the control knob with yet another foot-operated apparatus does not efficiently, much less naturally solve the problem, it merely reconfigures it.

### OBJECTS AND ADVANTAGES

Accordingly, several objects and their advantages of this remote control are presented below:
1) To provide operational control of floor-mounted audio effects devices from either a standing or sitting position with a device which:
   a) is cheaper to produce than the currently marketed device.
   b) is more discrete in operation than the currently marketed device - requires no floor space.
   c) may be used with any floor-mounted effects devices whether pedal or pedal-board type, regardless of the configuration of their potentiometers or foot-operated levers.
   d) can accomodate several potentiometers on any combination of processors with a single unit rather than the single potentiometer capability of the currently marketed device.
   e) is more natural to operate for the user than the currently marketed devices, which is foot-operated.
2) To signifigantly expand the performance applications of floor-mounted audio effects processors.
3) To establish an entirely new field of creative exploration and expression that did not previously exist.

Another advantage of this remote controller is its usefulness to musicians other than guitarists;
Vocal performers, Keyboardists, Recording Engineers, as well as “Solo” performers (who frequently have to operate multiple devices equipped with rotary potentiometers), will find this remote controller useful.

Also, due to the instrument-like characteristic resulting from the manipulation of a rotary potentiometer while an audio signal is present, the employment of this remote control enables the effects device itself to become a functional, playable ‘instrument’ with its own unique characteristics and potential. Thus, a useful synergy is made more accessable for practical application by musicians, singers, etc., further expanding the already signifigantly increased performance applications now possible with floor-mounted audio effects devices.

This invention not only provides a discreet, practical, economical and easy-to-use solution to a problem that has existed for over forty years, but also signifigantly expands their performance applications of the floor-mounted audio effect processors by allowing manipulation of their controls from a more natural position for the user.

Still further objects and advantages will become apparent from a consideration of the ensuing drawings and descriptions.

### DRAWINGS—FIGURES

FIG. 1 Shows three examples of typical floor-mounted audio effects devices.

FIG. 2 Shows view of rotary potentiometer.

FIG. 3 Shows remote controller in static (operating) position.

FIG. 4A Shows control unit being clipped to microphone stand.

FIG. 4B Shows wire rope being passed through loom assembly.

FIG. 4C Shows loom assembly being clipped to microphone stand.

FIG. 4D Shows removal of knob from audio signal processor.

FIG. 4E Shows u-joint in position over potentiometer.

FIG. 4F Shows thumb screw operation.

FIG. 5 Shows view of universal-joint operation.

FIG. 6 Is exploded view of preffered embodiment.

FIG. 7A Show example of flexible drive shafts (alternative embodiments).

FIG. 7B Shows geared mechanism (alternative embodiment).

FIG. 7C Shows example of rigid drive shaft.

FIG. 8 Shows example of flexible rubber hose or flexible tubing (alternative embodiment).

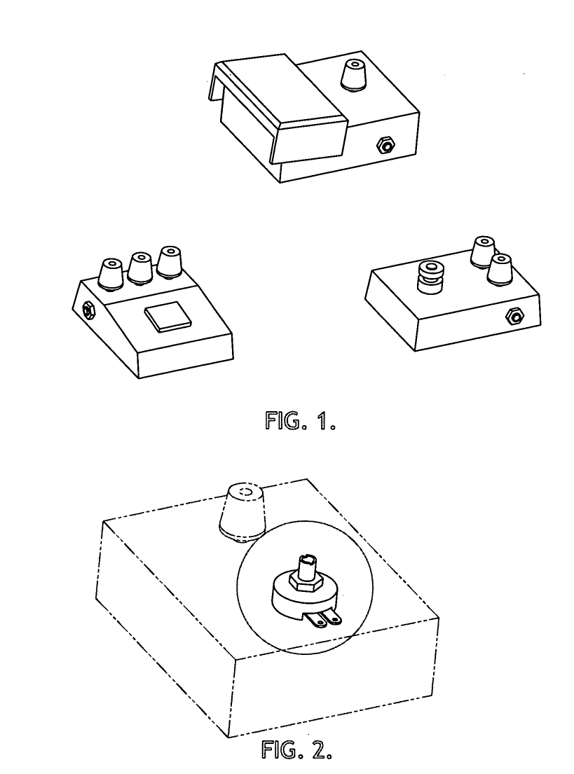

### DESCRIPTION PREFERRED EMBODIMENT

A piece of vinyl-coated, 7×7 strand, galvanized steel wire rope 24 approximately 91.4 cm in length and 0.47 cm in diameter is passed through a hole of equal diameter in a 5×2.5 cm mounting bracket 10, and is allowed to swivel in place 360° by means of a pair of shaft collars 4. Each having a set screw 6. A pair of 0.63 cm (I.D.) nylon bushings 8, are used to reduce friction, and both ends of the wire rope have a 2.5 cm length of 0.063 diameter vinyl heat-shrink 22 to provide a “snug” fit of the shaft collars and the universal joint 26.

A 1.8 cm diameter control knob 2 is epoxied in place directly over the shaft collar assembly for transmitting the hand-generated rotational force required to operate the remote. The mounting bracket is then attached to a microphone stand with a pair of steel clips 12 approximately 91.4 cm from ground level.

Approximately 30 cm below the control unit, a 3.8 cm diameter steel pinch clamp 28, which is provided with a steel clip identical to the above 12, is attached to the microphone stand to act as a loom and restrict lateral movement of the wire rope 24 during operation. Both the loom clip and the control unit clips are attached with a machine screw 14 and lock washer 16 and fastened with a flat washer 18, and a hex nut 20.

A universal joint 26 having an approximate length of 7 cm and inside bore of 0.63 cm is attached to the bottom end of the wire rope with general purpose epoxy, and a thumb screw 30 at the open end of the universal joint is used to “capture” and hold the potentiometer shaft.

This preferred embodiment is not limited to a single control; as many floor-mounted processors are equipped with several rotary potentiometers, a 2, 3, or 4 channel model is also a practical embodiment.

### Description-operation

### Preferred Embodiment

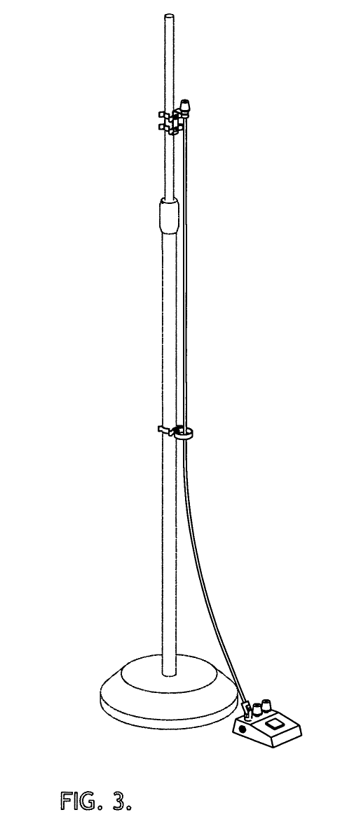

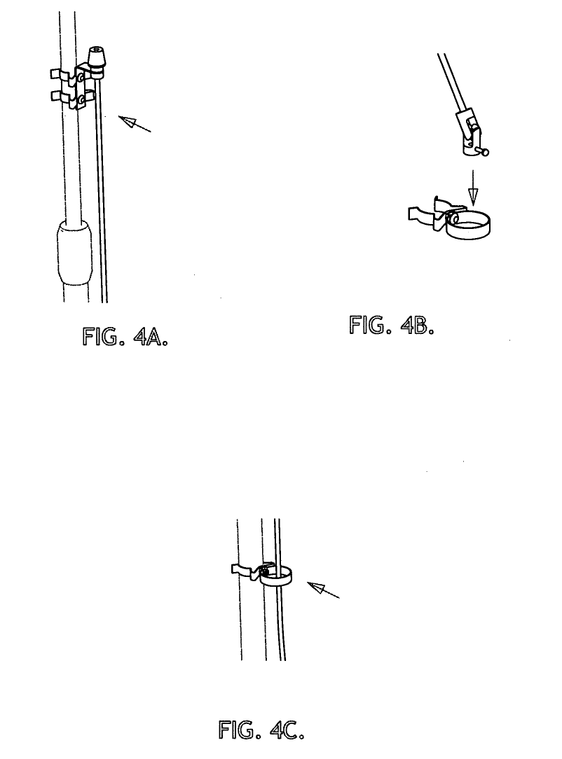

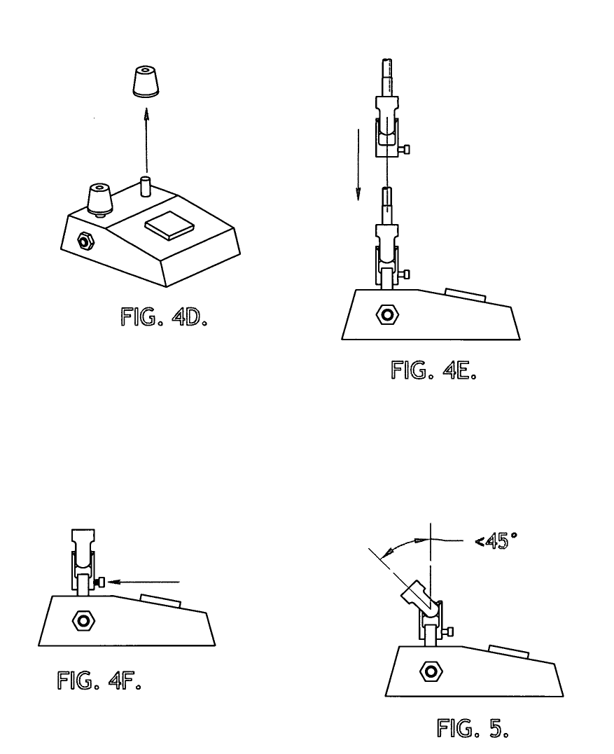

Operation—FIGS 3 through 4F

FIG. 3 shows device in operating position.

The control unit is first clipped to a microphone stand approximately 91.44 cm from the floor (FIG. 4A). The bottom end of the cable is then passed through the loom assembly (FIG. 4B), which is similarly clipped approximately 30 cm below the control unit (FIG. 4C).

The user then removes from his/her effects device the knob controlling the desired parameter (FIG. 4D), and turns the exposed potentiometer shaft to its “0” setting. The control knob of the remote is then also set to its “0” position.

Finally, the open bore of the universal joint is pushed into position over the exposed potentiometer shaft (FIG. 4E) and held in place with a thumb screw (FIG. 4F).

U-joint allows complete freedom of movement from any direction up to 45° from the vertical (FIG. 5).

### Alternative Embodiments

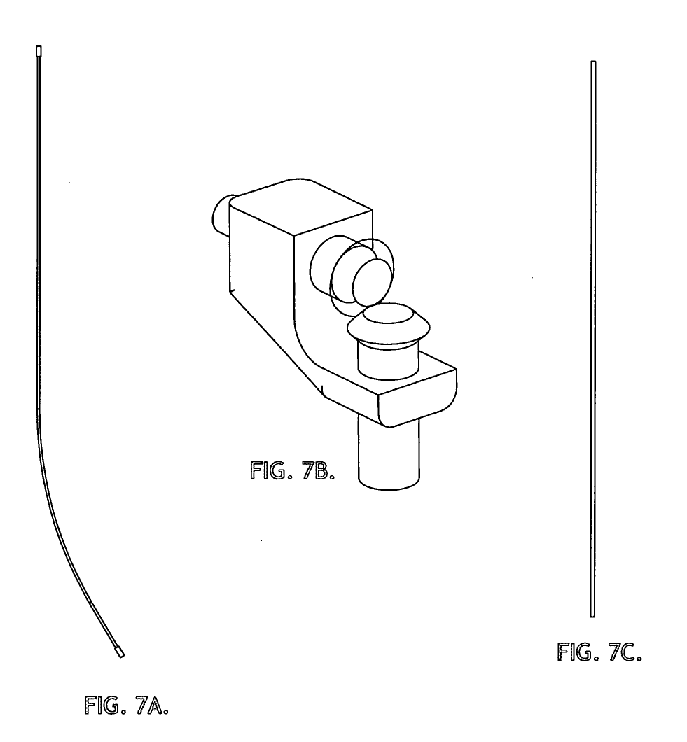

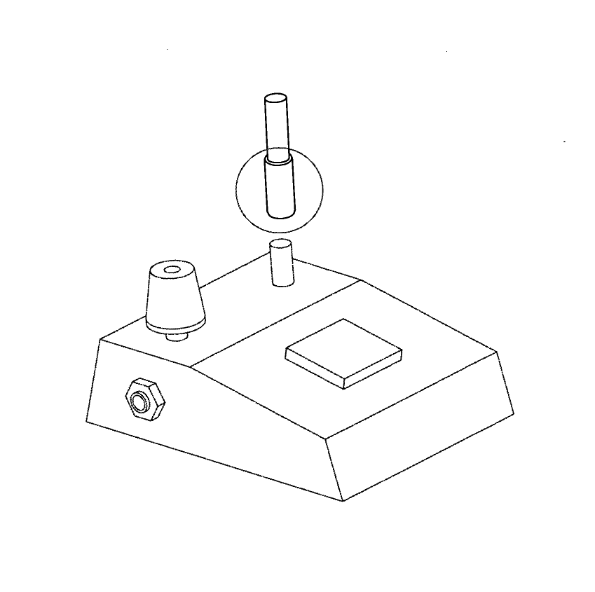

While the preferred embodiment incorporates a length of vinyl-coated wire rope and a nylon universal joint as the primary components of this remote, an additional embodiment could employ a panel-mount flexible drive shaft (FIG. 7A) in conjunction with a 90°, geared mechanism (FIG. 7B).

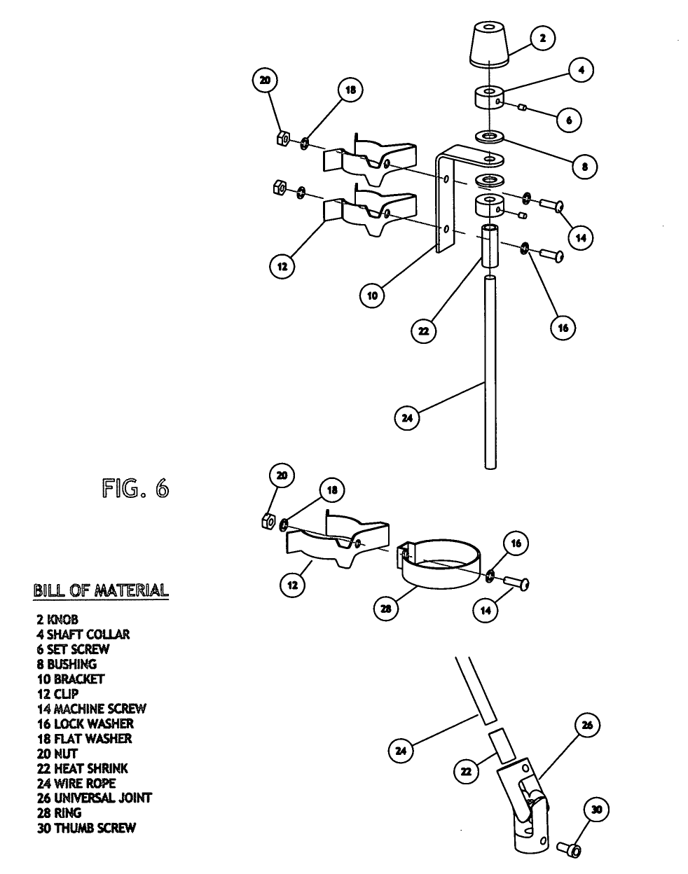

Alternately, a rigid shaft (FIG. 6C) constructed of a cheap, lightweight material (such as plastic) would, when combined with the nylon u-joint, result in a more discrete operational profile.

Also, a length of flexible rubber hose or other pliable tubing having an inside diameter of approximately 0.63 cm (FIG. 6D) may be used in place of the universal joint to capture the potentiometer shaft.

Still further, by utilizing the small, powerful micro-servos available today (like those used in radio-controlled hobby aircraft, cars, etc.,) a ‘wireless’ remote, capable of controlling multiple potentiometers from practically anywhere during a live performance, is yet another possible embodiment.

This would be useful not only with floor-mounted devices, but with any device equipped with rotary potentiometers, such as amplifiers, mixing consoles, etc,.

I claim:

1. Device for the remote operation of rotary potentiometers comprising:
(a) A support bracket having means for temporary adjunction to a support member and
(b) A control knob for the application of hand-generated rotational force and
(c) An arbor for transmission of rotational force and
(d) A pivotably-mounted coupling for transmission of rotational force from variable angles of operation and
(e) Said coupling having means for temporary adjunction to a rotary potentiometer shaft whereby a user may now operate floor-mounted audio-signal processors from a more natural standing position by eliminating the need to bend or crouch during a musical performance to operate said processors.
